(19) United States
(12) Patent Application Publication
(10) Pub. No.: US 2005/0162336 A1
(43) Pub. Date: Jul. 28, 2005

(54) System and apparatus for providing dual independent displays

(75) Inventors: David L. McClintock, Austin, TX (US); Ajay Kwatra, Austin, TX (US)

Correspondence Address: Attn: Bradley S. Bowling;Baker Botts L.L.P., 910 Louisiana Street, Houston, TX, 77002-4995, US

(73) Assignee: Dell Products L.P.

(21) Appl. No.: 10/765,554

(22) Filed: Jan. 27, 2004

(51) Int. Cl. G09G 5/00

(52) U.S. Cl. 345/1.1

(57) ABSTRACT

A video display controller for controlling multiple display devices is disclosed. The video display controller includes a graphics processing unit that is adapted to receive input and transmit output to one or more display devices. The video display controller also includes a single display device connector in communication with the graphics processing unit. The video display controller is adapted to independently control a first display device and a second display device through the display device connector.

### TECHNICAL FIELD

The present disclosure relates generally to the field of display devices for information handling systems, and, more particularly, to a system and an apparatus for providing dual independent displays for information handling systems.

### BACKGROUND

As the value and use of information continues to increase, individuals and businesses seek additional ways to process and store information. One option available to users of information is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may comprise one or more display devices. Multiple display devices are useful to a user of an information handling device by allowing the user to view more information simultaneously. Typically, an information handing system will include one display device connector for connection to a single display device for the information handling system. If additional display devices are to be associated with the information handling system, each additional display device connector takes up additional space in the interior of the information handing system, and each additional display device consumes surface area on or near the exterior of the information handling system. In many information handing systems, and in small form factor (SFF) computers in particular, additional space is not available to mount or house multiple display device connectors.

A video display controller used in an information handling system typically receives input from the central processing unit (CPU) and transmits a signal to the display device, which displays information to the user. One connector used for video display controllers is the Digital Visual Interface-Integrated (DVI-I) connector. The typical pin configuration of the DVI-I connector is shown in FIG. 1. The typical pin-out of the DVI-I controller is as follows:

| Pin | Function |
|---|---|
| 1 | TMDS Data 2− |
| 2 | TMDS Data 2+ |
| 3 | TMDS Data 2/4 Shield |
| 4 | TMDS Data 4− |
| 5 | TMDS Data 4+ |
| 6 | DDC Clock |
| 7 | DDC Data |
| 8 | Analog Vertical Sync |
| 9 | TMDS Data 1− |
| 10 | TMDS Data 1+ |
| 11 | TMDS Data 1/3 Shield |
| 12 | TMDS Data 3− |
| 13 | TMDS Data 3+ |
| 14 | +5 V Power |
| 15 | Ground |
| 16 | Hot Plug Detect |
| 17 | TMDS Data 0− |
| 18 | TMDS Data 0+ |
| 19 | TMDS Data 0/5 Shield |
| 20 | TMDS Data 5− |
| 21 | TMDS Data 5+ |
| 22 | TMDS Clock Shield |
| 23 | TMDS Clock+ |
| 24 | TMDS Clock− |
| C1 | Analog Red |
| C2 | Analog Green |
| C3 | Analog Blue |
| C4 | Analog Horizontal Sync |
| C5 | Analog Ground |

The DVI-I connector allows the connection of a digital monitor supporting the Transmission Minimized Differential Signaling (TMDS) protocol and an analog monitor through a dongle. The DVI-I connector supports both single-link and dual link TMDS signaling. In both single-link and dual-link TMDS signaling, the first TMDS link is established through pins 1-3, 9-11, and 17-19. In dual-link TMDS signaling the second TMDS link is established though pins 4-5, 12-13, and 20-21. In both single-link and dual-link TMDS signaling pins 22-24 are used for clock signaling. The pin-out for a DVI-I connector supports a single Data Display Channel (DDC) though pins 6 and 7. The DDC allows the display device to transmit its identity and capabilities to the video controller and allows the video controller to control the display device's settings (e.g., resolution and refresh rate). Signaling over the DDC may be accomplished using the Display Data Channel Command Interface (DDC/CI) promulgated by the Video Electronics Standards Association (VESA) of Milpitas, Calif. Although present video controllers using the DVI-I connector could be connected to a digital display device and an analog display device using a dongle, the two devices cannot be independently controlled because there is only one DDC channel.

### SUMMARY

In accordance with the present disclosure, a video display controller is disclosed that includes a graphics processing unit that can receive input and transmit output to one or more display devices. The video display controller also includes a single display device in communication with the graphics processing unit. The video display controller is adapted to independently control a first display device and a second display device through the single display device connector. A technical advantage of the present disclosure is that multiple display device can be connected to a single display device connector. This allows the information handling system to have multiple display devices without using more interior space or exterior surface area for mounting additional display device connectors. Another technical advantage of the present invention is that multiple display devices can be connected to an existing display device connector, allowing a user to use existing cabling to connect the display devices to the display device connector. Another technical advantage of the present invention is that existing protocols for transmitting display device information and controlling the display devices (DDC/CI) and existing protocols for transmitting video signals (TMDS and VGA) are employed. The use of existing protocols allows the system to be backward-compatible and makes for easier adoption. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of the pin configuration of a DVI-I connector;

FIG. 2 is a diagram of a information handling system with multiple display devices; and

FIG. 3 is a diagram of a information handling system with multiple display devices.

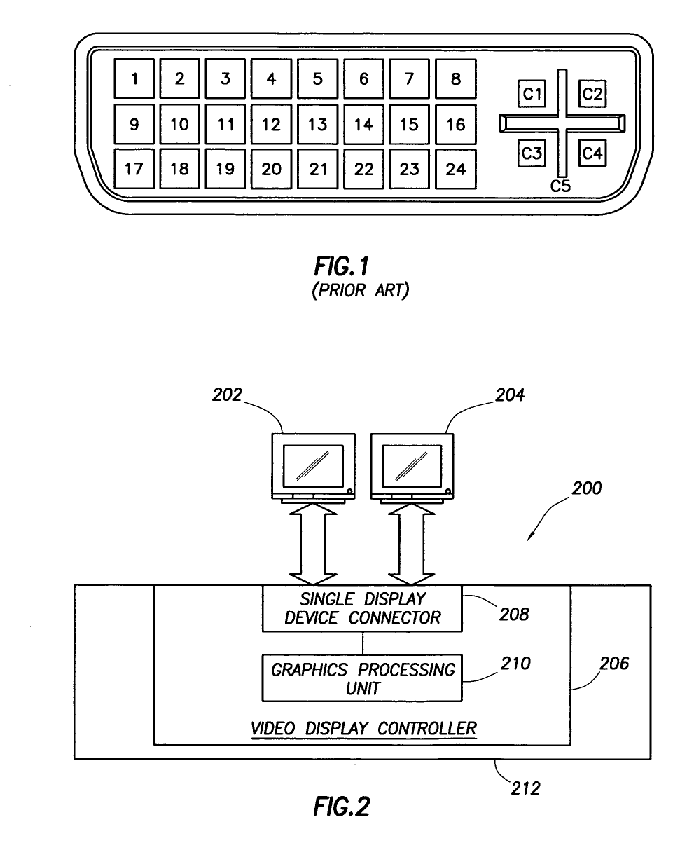

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a person computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. Information handling systems may include one or more nodes in a network.

The present disclosure concerns a system and an apparatus for independently controlling two display devices using a video display controller in which the video display controller controls the display devices thorough a single display device connector. Single display device connectors are defined as display device connectors that were originally designed to independently control only a single display device. Single display device connectors include, but are not limited to, a DVI-I connector, a Digital Visual Interface-Digital (DVI-D) connector, a Digital Visual Interface-Analog (DVI-A) connector, a 15-pin Video Graphics Adapter (VGA) connector, a 9-pin Monochrome Display Adapter/Computer Graphics Adapter/Enhanced Graphics Adapter (MDA/CGA/EGA) connector, an Apple Display Connector (ADC), an Apple Monitor Connector, and a Digital Flat Panel (DFP) connector. An example of a connector that was originally designed to independently control multiple display devices is offered by Molex, Inc. of Lislie, Ill. under the trademark “DMS-59.”

Shown in FIG. 2 is an information handling system, which is indicated generally at 200. Information handling system 200 includes a video display controller 206, a first display device 202, and a second display device 204. The video display controller 206 is generally contained within the housing 212. The video display controller 206 is in communication with both the first display device 202 and the second display device 204. Information handling system 200 will typically include one or more processors and memory, including random access memory (RAM) and types of non-volatile memory. Information handling system 200 will typically include one or more disk drives, one or more network ports for communicating with external devices, as well as various I/O devices, such as a keyboard and a mouse.

The housing 212 of the information handling system may be any suitable form for containing the components of an information handling system. Depending on the configuration and use of the information handling system, the form factor of the housing may be space-constrained or limited in its size. One example of a space-constrained form factor is the Small Form Factor (SFF) housing. In general, computers with SFF housings are designed to be used in a fixed manner, yet are smaller than conventional desktop information handling systems. There is, however, no standardized size for SFF housings. Another example of a space-constrained form factor is the housing of a laptop or a notebook computer. Housing 212 may have insufficient internal space or external surface area to accommodate multiple display device connectors.

Video display controller 206 includes a graphics processing unit 210, which communicates with a single display device connector 208. Each of the first display device 202 and the second display device 204 communicates with the video display controller 206 through a single display device connector 208. The video display controller 206 is capable of transmitting data to the first display device 202 and the second display device 204 according to different transmission protocols. As an example, video display controller 206 is operable to transmit data according to standard analog VGA signaling over a VGA communications link. In another example, video display controller 206 is operable to transmit data using TMDS over a TMDS communications link. In another example, video display controller 206 may simultaneously use both VGA signaling and TMDS. In this configuration, video display controller 206 may use VGA signaling to transmit information to the first display device 202, while using TMDS to transmit information to the second display device 204. As an alternative, video display controller 206 may communicate with both the first display device and the second display device according to either the VGA signaling protocol or the TMDS protocol.

Graphics processing unit 210 includes logic and circuitry to control the settings of the display devices and to receive configuration data from each of the display devices. Graphics processing unit 210 communicates with the display devices over two DDC links using the DDC/CI protocol on each link. Graphics processing unit 210 is capable of independently controlling the resolution and refresh rate of the first display device 202 and the second display device 204. Graphics processing unit 210 is operable to receive configuration data from each of the display devices over DDC channels that are independent to each display device.

Single display device connector 208 may include any connector configuration originally designed for the control of a single display device. In one example of the present invention, the single display device connector 208 is a DVI-I connector. To facilitate the independent control of the first display device 202 and the second display device 204 through a single display device connector, video display controller 206 must forego the use of dual channel TMDS communication with the display devices. Foregoing the use of dual channel TMDS communication frees the pins assigned to the second TMDS link (pins 4-5, 12-13, and 20-21) for other uses. For example, any two of the pins originally assigned to the second TMDS link may be used as a second DDC communication link. Alternatively pins for the first TMDS link may be reassigned and used for the second DDC communication link. A pin-out of the single display device connector 208, including the placement of a second DDC channel over pins originally assigned to the second TMDS link is shown below:

| Pin | Function |
|---|---|
| 1 | TMDS Data 2− |
| 2 | TMDS Data 2+ |
| 3 | TMDS Data 2/4 Shield |
| 4 | No connection |
| 5 | DDC Data 2 |
| 6 | DDC Clock 1 |
| 7 | DDC Data 1 |
| 8 | Analog Vertical Sync |
| 9 | TMDS Data 1− |
| 10 | TMDS Data 1+ |
| 11 | TMDS Data 1/3 Shield |
| 12 | No connection |
| 13 | DDC Clock 2 |
| 14 | +5 V Power |
| 15 | Ground |
| 16 | Hot Plug Detect |
| 17 | TMDS Data 0− |
| 18 | TMDS Data 0+ |
| 19 | TMDS Data 0/5 Shield |
| 20 | Dongle Detect |
| 21 | No Connection |
| 22 | TMDS Clock Shield |
| 23 | TMDS Clock+ |
| 24 | TMDS Clock− |
| C1 | Analog Red |
| C2 | Analog Green |
| C3 | Analog Blue |
| C4 | Analog Horizontal Sync |
| C5 | Analog Ground |

In the pin-out configuration shown above, a first DDC communication link is provided over pins 6 and 7, and a second DDC communication link is provided over pins 5 and 13. It should be recognized that any of the pins of the single display device connector can be configured to provide the second DDC communications link. Using the pin-out configuration above for a single display device connector 208, the video display controller 206 can independently control display device 202 and display device 204. In this example, display device 202 is a digital display that supports TMDS and display device 204 is an analog display device that supports VGA signaling. In the pin-out detailed above, pin 20 is reserved for a dongle detection circuit.

In another example of the assignment of pins of a single display device connector 208 to permit the independent control of first and second display devices, any two of the pins originally reserved for VGA signaling (pins 8 and C1-C5) may be used as a DDC communications link. In one example, pin C1 could be used as a second DDC Data channel and pin C2 could be used as a second DDC clock channel. In such a configuration, a single display device connector could support two digital displays, with each digital display connected to the video display controller 206 over a single TMDS channel. The single display device connector 208 may also use one of the pins originally reserved for VGA signaling as a dongle detect pin, so that the video display controller 206 will be able to detect when a dongle is connected to the single display device connector 208.

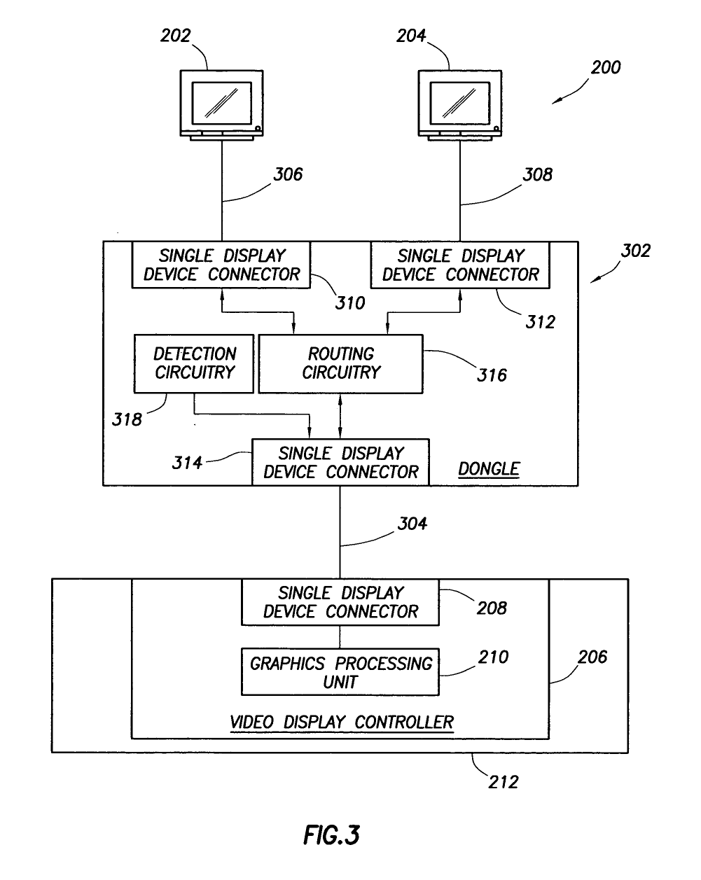

Shown in FIG. 3 is an example of an information handling system 200 that includes a dongle 302 that includes three display device connectors 310, 312, and 314 and routing circuitry 316 in communication with the single display device connectors 310, 312, and 314. Single display device connector 314 is connected to the video display controller 206 and single display devices connectors 310 and 312 are connected to the display devices. Another example of dongle 302 includes cabling to connect the dongle 302 to the display devices and the video display controller in place of the single display device connectors 310, 312, and 314.

Dongle 302 also includes routing circuitry 316. Routing circuitry 316 acts as a splitter, sending the correct signals to each device. I/O from the video display controller 206 is routed to and from display device 202 or 204, depending on what pins of the single display device connector 314 the I/O is traveling on. For example, if the display device 202 is a digital display while display device 204 is a VGA display, the routing circuitry will route the TMDS video signaling to signal display device connector 310 and will route the VGA video signaling to the single display device connector 312. In another example, the first DDC is routed from the video display controller to the first display device 202, while the second DDC is routed from the video display controller 206 to the second display device 204.

Dongle 302 also includes detection circuitry 318. The detection circuitry 318 allows the video display controller 206 to selectively operate in a backward-compatible manner (e.g., independently controlling one display device) and as a dual-display device controller. In operation, if the video display controller 206 detects that the dongle is connected by the detection circuit 318 pulling one pin of the single display device connector 314 to an arbitrary logic state (e.g., high or low). The video display controller 206 will recognize that that the dongle 302 is connected and it can begin independently controlling two display device. If, however, the video display controller 206 does not detect the dongle, it independently controls only a single display device.

Dongle 302 is coupled to display device 202 through communication link 306, and dongle 302 is coupled to display device 204 through communication link 308. Dongle 302 is coupled to single display device connector 208 through communications link 304. Dongle 302 includes circuitry to route signals from the video display controller 206 to the appropriate display device. For example, if display device 202 is an analog display and display device 204 is a digital display the dongle 302 will route the VGA signaling channel and the first DDC to the display device 202 and the TMDS channel and the second DDC channel to the display device 204. In another example, if the first display device 202 and the second display 203 are digital display devices, the dongle 302 will route the first TMDS channel and the first DDC to the first display device 202 and the second TMDS channel and the second DDC to the second display device 204. In addition to routing circuitry, dongle 302 may also include connectors to couple the dongle 302 to the single display device connector 208 and for coupling the first display device 202 and the second display device 204 to the dongle 302. These connectors may include male or female DVI-I connectors and male or female VGA connectors.

In operation, a DVI cable is connected between the single display device connector 208 and the dongle 302. If the first display device 202 is an analog VGA display device, a VGA cable is connected between the dongle 302 and the first display device 202. If the first display device is a digital display device, a DVI cable is connected between the dongle 302 and the first display device 202. If the second display device 204 is an analog VGA display device, a VGA cable is connected between the dongle 302 and the second display device 204. If the second display device is a digital display device, a DVI cable is connected between the dongle 302 and the second display device 204.

When the dongle 302 is connected to the single display device connector 208, the video display controller 206 detects that the video display controller is attached by an arbitrary logic state on the dongle detect pin. The arbitrary logic state may be a high or a low logic state. Once the video display controller 206 detects that the dongle 302 is connected, it may begin to independently operate the display devices. The video display controller may receive, over the DDC links, configuration information concerning the first display device 202 and the second display device 204. The video display controller 206 may adjust configuration settings of the first display device 202 and the second display device 204 over the DDC links. The video display controller 206 may send video signal to the first display device 202 using TMDS or VGA signaling, depending on the configuration of the system.

The system described herein for independently controlling the display devices may be implemented in software, firmware, or hardware in the video display controller or other elements of the information handling system. Although the present disclosure has been described in detail, it should be understood that various changes, substitutions, and alterations can be made hereto without departing from the spirit and the scope of the invention as defined by the appended claims.

1. A video display controller, comprising:
a graphics processing unit adapted to receive input and transmit output to one or more display devices; and
a single display device connector in communication with the graphics processing unit;
wherein the video display controller is adapted to independently control a first display device and a second display device through the display device connector.

2. The video display controller of claim 1, wherein the display device connector is a DVI-I connector.

3. The video display controller of claim 1, wherein the first display device is an analog display device.

4. The video display controller of claim 1, wherein the second display device is a digital display device.

5. The video display controller of claim 1, further comprising a first control channel and a second control channel.

6. The video display controller of claim 5, wherein the first control channel is adapted to use a Display Data Channel Command Interface.

7. The video display controller of claim 5, wherein the second control channel is adapted to use a Display Data Channel Command Interface.

8. A dongle for connecting a video display controller with a first display device and a second display device, the video display controller comprising a graphics processing unit adapted to receive input and transmit output to one or more display devices, the video display controller further comprising a single display device connector in communication with the graphics processing unit, and wherein the video display controller is adapted to independently control the first display device and the second display device through the display device connector, the dongle comprising:
routing circuitry capable of:
routing a first video channel and a first control channel from the video display controller to the first display device, and
routing a second video channel and a second control channel from the video display controller to the second display device.

9. The dongle of claim 8, wherein the first video channel is a TMDS channel and the second video channel is an analog VGA channel.

10. The dongle of claim 8, wherein the first video channel is a TMDS channel and the second video channel is a TMDS channel.

11. The dongle of claim 8, wherein the first control channel and the second control channel are adapted to use a Display Data Channel Command Interface.

12. The dongle of claim 8, further comprising a dongle detection circuit, wherein the dongle detection circuit signals the video display controller that the dongle is attached to the video display controller.

13. An information handling system, comprising:
a first display device;
a second display device;
a video display controller in communication with the first display device and the second display device, the video display controller comprising:
a graphics processing unit adapted to receive input and transmit output to one or more display devices; and
a single display device connector in communication with the graphics processing unit;
wherein the video display controller is adapted to independently control the first display device and the second display device through the single display device connector;

14. The information handling system of claim 13, further comprising a housing, wherein the video display controller is generally within the housing.

15. The information handling system of claim 14, wherein the housing is a Small Form Factor (SFF) housing.

16. The information handling system of claim 14, wherein the housing is a laptop housing.

17. The information handling system of claim 13, wherein the first display device is an analog display device.

18. The information handling system of claim 13, wherein the second display device is a digital display device.

19. The information handling system of claim 18, wherein the second display device is capable of receiving TMDS.

20. The information handling system of claim 13, further comprising:
a dongle comprising circuitry capable of:
routing a first video channel and a first control channel from the video display controller to the first display device, and
routing a second video channel and a second control channel from the video display controller to the second display device.
